(19) United States
(12) Patent Application Publication
(10) Pub. No.: US 2010/0032299 A1
(43) Pub. Date: Feb. 11, 2010

(54) MICROELECTRONIC DEVICE WITH ELECTRODES FOR MANIPULATING A SAMPLE

(75) Inventor: David Andrew Fish, Haywards Heath (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/376,634

(22) PCT Filed: Jul. 10, 2007
(86) PCT No.: PCT/IB07/52739

§ 371 Date: Feb. 6, 2009

(30) Foreign Application Priority Data
Aug. 9, 2006 (EP) 06118676.3

(51) Int. Cl. B03C 5/02

(52) U.S. Cl. 204/643

(57) ABSTRACT

The invention relates to a microelectronic device with an array (10) of field electrodes (11) that are individually addressable and can for example generate dielectrophoretic forces on particles (2) above the array (10). In a preferred embodiment, the field electrodes (1) can selectively be put to one of two phase-inverted potentials (+,−) or a floating potential (Z). Various space saving circuits are described that allow the operation of the field electrodes (11) with a minimal number of components.

The invention relates to a microelectronic device for manipulating a sample, comprising an array of field electrodes that can selectively be connected to a voltage supply. Moreover, it relates to the use of such a microelectronic device and to a method for the manipulation of particles in a sample chamber above an array of field electrodes.

The U.S. Pat. No. 6,942,776 B2 discloses a microelectronic device with an array of electrodes on the bottom side and a single planar counter electrode on the top side of a microfluidic chamber. By connecting the electrodes selectively to one of two phase-inverted voltages, potential cages can be created in the sample chamber in which particles can be trapped. The document does however not describe any circuits for driving the field electrodes.

Based on this situation it was an object of the present invention to provide means for manipulating a sample with an array of field electrodes, wherein it is desirable that a simple, cost-effective and space-saving driving of field electrodes is achieved.

This objective is achieved by a microelectronic device according to claim 1, a method according to claim 18, and a use according to claim 19. Preferred embodiments are disclosed in the dependent claims.

According to its first aspect, the invention relates to a microelectronic device for manipulating a sample, wherein the term “manipulation” shall denote any interaction with said sample, for example measuring characteristic quantities of the sample, investigating its properties, processing it mechanically or chemically or the like. The sample will usually be provided in a sample chamber, e.g. an empty cavity or a cavity filled with some substance like a gel that may absorb a sample substance, wherein the cavity may be open, closed, or connected to other cavities by fluid connection channels. The microelectronic device comprises the following components:
a) A first voltage supply, which typically comprises a generator for generating a required voltage, particularly a sinusoidal wave, and lines to distribute said voltage to the locations where it is needed. Here and in the following, the adjective “first” is used to distinguish one component from another component (the “second”) that is optionally present in preferred embodiments; the adjective “first” shall therefore not imply that there must be another component. Moreover, a “first” and a “second” component may in some cases only be logically different but realized by the same piece of hardware.
b) A controller comprising controlling circuitry and addressing circuitry. The controller may partially or completely be realized on one substrate with other components of the microelectronic device and may for example comprise integrated circuits and/or a microcontroller. The controlling circuitry and the addressing circuitry typically comprise lines that are needed to access the associated locations (particularly the field electrodes mentioned below).
c) An array of field electrodes, wherein the term “field” shall without any restriction only indicate that said electrodes are typically intended for generating an electrical field. It should be noted that the device may optionally comprise further (field) electrodes besides those belonging to the aforementioned array, wherein each of the latter field electrodes is associated to:
c1) a first controllable switch for selectively connecting the field electrode to the first voltage supply; and
c2) a first addressing unit that allows the controlling circuitry to control the first controllable switch if the first addressing unit is selected by the addressing circuitry. In this respect, the “controlling of a switch” shall mean that the state of said switch (“closed” or “open”) is set and remains as set until it is controlled otherwise.

With the aforementioned microelectronic device, any desired state of electrode activity, i.e. connection or disconnection of the field electrodes to the first voltage supply, can be programmed into the array by addressing the addressing units and controlling the associated field electrodes as desired. To achieve this functionality, the device requires only local controllable switches that establish and keep the desired (dis-)connection to the first voltage supply after controlling.

According to a preferred embodiment of the microelectronic device, at least one of its field electrodes can selectively be disconnected from any voltage supply. It is therefore possible to operate this field electrode deliberately in a floating state, which offers new opportunities compared to known electrode arrays (e.g. that of U.S. Pat. No. 6,942,776 B2) in which the electrodes are necessarily coupled to one of two (phase-inverted) voltage supplies.

In a further development of the aforementioned embodiment, a region of field electrodes that are disconnected from any voltage supply can the established, wherein said region is surrounded by field electrodes connected to some voltage supply (e.g. to the first voltage supply). The resulting island of one or more floating electrodes can for example be used to create potential cages that can trap particles without the need for an opposing counter electrode.

The microelectronic device preferably comprises a second voltage supply, wherein each field electrode of the array is associated to a second controllable switch for selectively connecting it to said second voltage supply. In this case it is possible to program the array of field electrodes with a pattern of two voltages. Moreover, the first and the second voltage supply may particularly provide phase-inverted alternating voltages. This allows to generate dielectrophoretic forces on particles above the array of field electrodes.

The aforementioned second controllable switch is optionally coupled to a second addressing unit that is associated to the corresponding field electrode and that allows the controlling circuitry to control the second controllable switch if the second addressing unit is selected by the addressing circuitry. Providing the second switch with an addressing unit of its own allows to control it independently from the first switch. Both switches can therefore be opened simultaneously, which usually provides a floating state of the associated field electrode.

In an alternative embodiment, the second controllable switch is coupled to the first addressing unit of the corresponding field electrode, wherein said first addressing unit allows the controlling circuitry to control the second controllable switch if the first addressing unit is selected by the addressing circuitry. This embodiment has the advantage that one addressing unit is shared by two controllable switches, which saves hardware components and therefore space on the microchip, wherein said space can favorably be used to build smaller field electrodes.

In a further variant of the invention, the first controllable switch comprises a first capacitor and/or the second controllable switch (if present) comprises a second capacitor, wherein said capacitors can store switching-state information provided by the controlling circuitry. Capacitors provide a comparatively simple and reliable means for storing e.g. a voltage that indicates the requested state (“closed” or “open”) of an associated switch.

In a further development of the above embodiment, the first controllable switch comprises a first transistor which is connected with its gate to the first capacitor and/or the second controllable switch comprises a second transistor which is connected with its gate to the second capacitor. A voltage that has been stored on the capacitors is thus applied to the gate of the associated transistor and therefore determines if the transistor will be conductive or nonconductive.

In the aforementioned embodiment, the gate of the second transistor may optionally be inverted with respect to the gate of the first transistor. A given potential (positive or negative) will then have opposite effects on the conducting state of the first and second transistor, respectively, which allows to use one single potential for controlling the transistors anti-cyclically.

The first and the second capacitor may optionally be identical, i.e. be realized by the same hardware. The information stored on this capacitor will then be used to determine the switching-state of both the first and the second associated switch. This can favorably be combined with the aforementioned embodiment, as the voltage provided by the single capacitor has opposite effects on the normal and the inverted gate of the first and the second transistor, respectively; this guarantees that they are always in opposite switching states, connecting the field electrode either to the first or to the second voltage supply.

The first and/or the second capacitor may be coupled to a reference voltage with one of its two terminals. Connecting the other terminal to the controlling circuitry will then allow to charge the capacitor with the difference between the reference voltage and a voltage provided by the controlling circuitry.

Alternatively, the first capacitor may be coupled to the second voltage supply with a one terminal, and the second capacitor may be coupled to the first voltage supply with one terminal. In contrast to the aforementioned embodiment, no reference voltage is needed in this case, leading to corresponding savings in hardware components (lines etc.) and space.

The first and the second capacitor may optionally be coupled to each other with their second terminals. As will be explained in more detail with reference to the Figures, this approach is particularly suited in combination with the aforementioned embodiment as a defined potential can then be provided at the second terminals of the capacitors which can for example uniquely drive transistor switches.

In a further development of the invention, the microelectronic device comprises at least one additional switch that can disconnect at least one field electrode from any voltage supply if the addressing unit that is associated to said field electrode is selected by the addressing circuitry. The disconnection of the field electrode from any voltage supply helps to avoid parasitic current flow during the programming procedure.

The controller of the microelectronic device is preferably adapted to drive the array of field electrodes such that particles can be manipulated, trapped and/or moved in a sample chamber above the array of field electrodes. The controller may for example establish (moving) potential cages above the array of field electrodes in which particles can be trapped.

The microelectronic device is preferably realized in CMOS technology or in Large Area Electronics (LAE), particularly LAE using Low Temperature Poly-Silicon (LTPS). The use of an LAE matrix approach, even more preferably an active matrix approach, to contact the field electrodes and/or other components is advantageous as it reduces the number of required input/output contacts to the outside world. Large area electronics, and specifically active matrix technology using for example Thin Film Transistors (TFT), is commonly used in the field of flat panel displays for the drive of many display effects e.g. LCD, OLED and Electrophoretic. The (metal) field electrodes may be additionally deposited on top of a backplane containing the active matrix electronics. In another embodiment, the metal layers used to built the active matrix components (e.g. TFTs, diodes) are also used to make the field electrode layers.

The invention further relates to a method for the manipulation of particles in a sample chamber above an array of field electrodes, wherein the field electrodes are activated in a pattern comprising electrodes on a positive or a negative potential and electrodes on a floating potential.

As was already described in connection with the microelectronic device, the provision of floating electrodes can favorably be used to create novel potential distributions that allow the trapping of particles even without a counter electrode to the array.

The invention further relates to the use of the microelectronic devices described above for molecular diagnostics, biological sample analysis, or chemical sample analysis, food analysis, and/or forensic analysis. Molecular diagnostics may for example be accomplished with the help of magnetic beads or fluorescent particles that are directly or indirectly attached to target molecules.

These and other aspects of the invention will be apparent from and elucidated with reference to the embodiment(s) described hereinafter. These embodiments will be described by way of example with the help of the accompanying drawings in which:

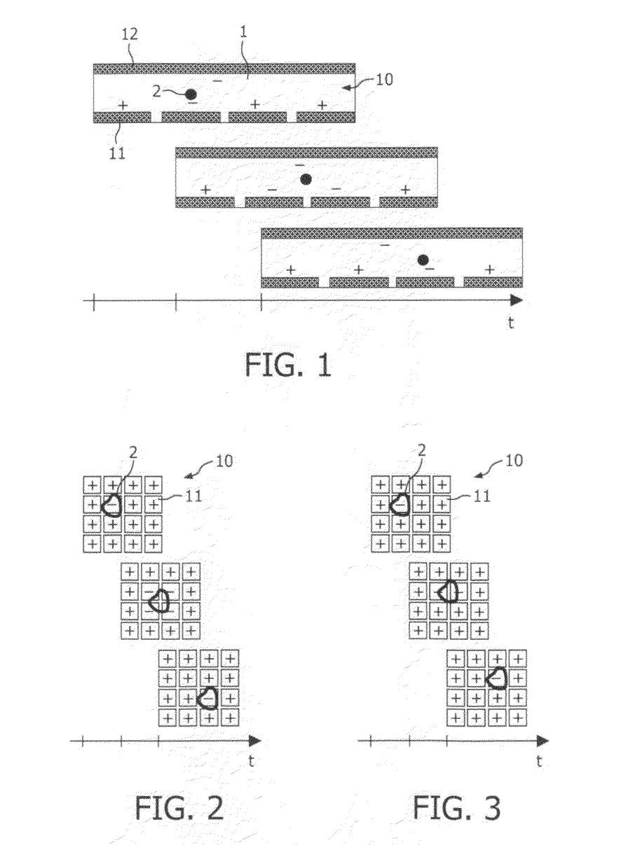

FIG. 1 schematically shows a section through a sample chamber with an array of field electrodes on its bottom and a counter electrode on its top in three consecutive stages during which the electrodes are operated with positive and negative potentials to move a particle by dielectrophoretic forces;

FIG. 2 schematically shows a top view of a two-dimensional array of field electrodes in three consecutive stages during which the electrodes are operated with positive and negative potentials to move a particle diagonally across the array by dielectrophoretic forces;

FIG. 3 shows a similar situation as FIG. 2, wherein the particle is moved horizontally across the array;

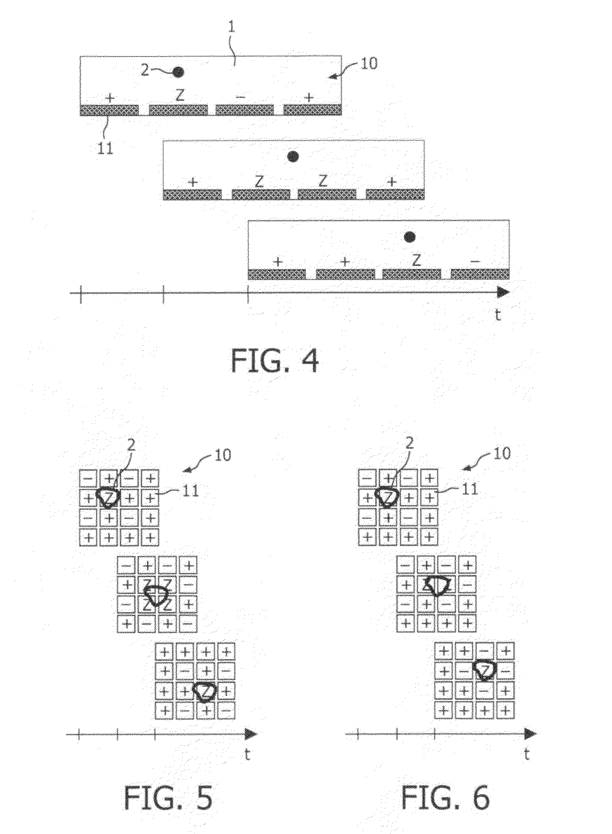

FIG. 4 schematically shows a section through a sample chamber with an array of field electrodes on its bottom in three consecutive stages during which the electrodes are operated with positive, negative and floating potentials to move a particle by dielectrophoretic forces;

FIG. 5 schematically shows a top view of a two-dimensional array of field electrodes in three consecutive stages during which the electrodes are operated with positive, negative and floating potentials to move a particle diagonally across the array by dielectrophoretic forces;

FIG. 6 shows a similar situation as FIG. 5, wherein the particle is moved horizontally across the array;

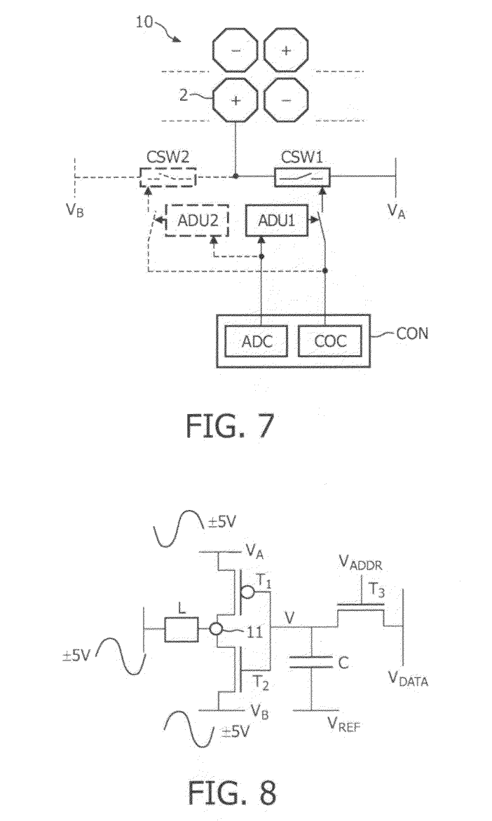

FIG. 7 shows schematically the general driving circuitry that is associated to a field electrode according to the present invention;

FIG. 8 shows a first concrete embodiment of the driving circuitry, comprising a capacitor connected to a reference voltage;

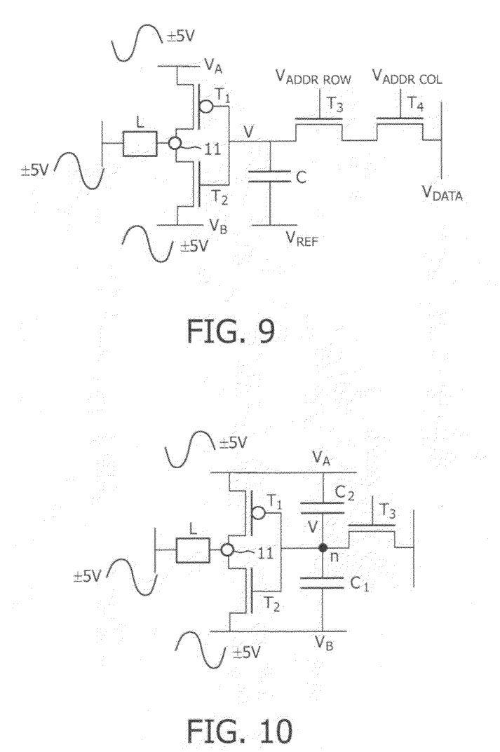

FIG. 9 shows a variant of FIG. 8, in which separate row and column address lines are used;

FIG. 10 shows a variant of FIG. 8, in which two capacitors are used and coupled to supply voltages instead of a reference voltage;

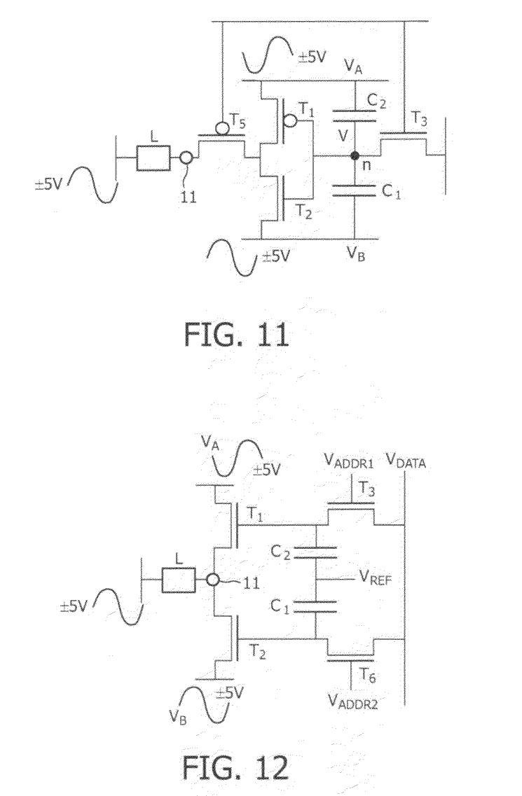

FIG. 11 shows a variant of FIG. 10, in which an additional switch is used to decouple the field electrode during the controlling process;

FIG. 12 shows a variant of FIG. 8, in which two capacitors are used to allow an independent controlling of the associated transistors.

Like reference numbers in the Figures refer to identical or similar components.

Micro-fluidics is essential for most biotechnology applications when bio-particles require movement from one location to another. Bio-particle manipulation is for example needed in many Lab-On-A-Chip applications, and being able to individually control large numbers of cells over comparatively large areas allows massively parallel operations for speed increases and cost reductions. This can have major benefits in areas such as drug discovery, proteomics, clinical analysis and point-of-care applications.

As many bio-particles (e.g. cells and viruses and some bio-molecules) are uncharged, the use of the standard electrophoretic techniques for particle manipulation requires that charge is added to the particle, which is often undesirable. Dielectrophoretic (DEP) forces can be induced in uncharged particles with non-uniform AC fields and can be positive or negative depending upon the dielectric properties of the particle and the fluid surrounding it. DEP forces are therefore ideally suited for micro-fluidic applications that require bio-particle manipulation like moving, trapping or rotating particles for detection, analysis and diagnostics. Moreover, the AC fields used in DEP tend to prevent the undesirable effects of electrolysis which is a side effect of the DC fields applied for electrophoresis. Therefore even with charged particles (e.g. DNA) DEP is advantageous for particle movement in fluids.

FIG. 1 shows in this respect at, from top to bottom, three consecutive points in time t a section through a microfluidic sample chamber or channel 1 in which a sample comprising (bio-)particles 2 is provided. A one- or two-dimensional array 10 of individually addressable field electrodes 11 is located on a substrate at the bottom of the sample chamber 1, while an upper glass plate of the sample chamber 1 is coated with a conducting planar counter-electrode 12.

Applying different AC potentials (whose phase is indicated by + and − signs) to the field electrodes 11 allows to create potential cages in the sample chamber 1 in which the particles 2 can be trapped. By moving the activation pattern of the field electrodes as illustrated in the three consecutive stages shown in FIG. 1, the particles 2 can be moved in a desired direction. This moving trap method operates in a manner similar to CCDs. The particles 2 are maintained in fluid between electrode array 10 and the counter-electrode 12, which is driven with the minus (−) phase. In the upper picture, the trap is formed between two positive phases (+) on the substrate and the negative phase on the counter-electrode 12, and a particle 2 is trapped over a negative phase. In the middle picture, the third electrode from the left is changed from the plus (+) phase to the minus (−) phase. The centre of the trap then moves to the centre of the two minus (−) phase electrodes and this pushes the particle over to the midpoint of the minus (−) electrodes. In the lowest picture, the second electrode is then taken to a plus (+) phase and pushes the particle 2 onwards to a position over the third electrode.

FIGS. 2 and 3 illustrate similarly in a top view on a two-dimensional array 10 of field electrodes 11 at consecutive points in time, how the movement of a particle 2 in diagonal (FIG. 2) and horizontal (FIG. 3) direction can be achieved. Typical applications of the shown microelectronic devices are Lab-on-a-chip, molecular diagnostics, rapid disease detection and rapid assessment of bacterial resistance to antibiotics.

While the embodiments shown in FIGS. 1, 2, and 3 require an upper counter-electrode 12, it is also possible to implement moving traps without such an upper electrode (a glass cover plate is however still advisable). This is shown in FIGS. 4 to 6 in similar sectional (FIG. 4) and top (FIGS. 5, 6) views of an electrode array 10. In this scheme there are three states of the field electrodes 11, namely a plus (+) phase, a minus (−) phase, and high impedance or floating state (Z). The moving trap scheme starts e.g. in the upper picture of FIG. 4 in a state in which the particle 2 is trapped over the Z electrode by the plus (+) and minus (−) phases on either side. In the middle picture, the third electrode assumes a Z state, and the particle 2 moves to the midpoint of the two Z electrodes. In the lowest picture, the second electrode assumes a plus (+) state, and the particle 2 is pushed over to the third electrode.

FIGS. 5 and 6 similarly show a 2D array 10 of electrodes 11 and phases that enable particle movement diagonally and horizontally.

In the following, a suitable driving circuit for operating field electrodes used in the above embodiments will be considered in more detail, starting with a closer view to the principles of dielectrophoretic (DEP) forces.

The DEP force scales as the cubed ratio of particle dimension to electrode spacing where the electrodes cause the non-linear electric field that generates the DEP force. Therefore at unity voltage the particle should be of a similar size to driving electrode spacing to provide a dominating force e.g. greater than forces due to Brownian motion. At higher voltages the spacing can become greater, but every effort should still be made to reduce the electrode spacing to the minimum possible (cf. L. Zheng, S. Ki, P. J. Burke, J. P. Brody: “Towards single molecule manipulation with dielectrophoresis using nanoelectrodes”, Proceedings of the 3rd IEEE conference on Nanotechnology, 1, p. 437 (2003)). To provide massively parallel movement and trapping of particles for analysis and diagnosis, a closely packed array is the most efficient solution.

Four electrodes can trap a particle if they are driven as a quadrupole, i.e. if opposite electrodes have the same and neighboring electrodes have a different AC phase. FIG. 7 shows this exemplarily for four electrodes 11, where the + and − signs indicate the phase of the AC field applied to the electrode. The whole array 10 will typically consist of many of these electrodes 11, and traps can be generated at the intersection of any four electrodes if the correct phases are applied. To create traps at any desired location, one needs to be able to independently address each electrode 11 of the array 10 so that one can select which AC phase is applied to the electrode.

As explained above, the size of a particle one wishes to trap is intimately linked to the electrode spacing. One should therefore make the most efficient use of the area available under an electrode 11 to fit the electronics required for driving it, i.e. the electronics under the electrode will limit the minimum size of field electrode and therefore the minimum size of particle that can be trapped. For large particles, the array will be large and one can use the cheapest technology available to do this and push this technology to its limits by reducing the amount of electronics under each electrode to its minimum so that the smallest particles possible can be trapped before one has to move to a finer resolution and more expensive technology. Large Area Electronic (LAE) technologies such as Low Temperature Poly-Silicon (LTPS) can for example be used to implement these schemes over large glass areas at low cost when compared to crystalline silicon CMOS.

In the following, simple circuit solutions are proposed for driving the electrodes of a DEP trap array. This allows the reduction of the electrodes to the lowest possible size in a closely packed array, enabling cost effective solutions through all silicon based technologies.

FIG. 7 shows schematically the basic layout of a driving circuitry according to the present invention. The associated microelectronic device comprises an array 10 of field electrodes, of which only the already mentioned four electrodes 11 (driven as a quadrupole) are depicted in the Figure. The driving circuitry is shown for one of these electrodes 11 in more detail. It comprises a first controllable switch CSW1 which can connect or disconnect the field electrode 11 to or from a first voltage Supply V_{A}. The switching-state of this first switch CSW1 is controlled by a controlling circuitry COC located outside the array 10 in a controller CON. The access of this controlling circuitry COC to the controllable switch CSW1 is controlled by a local addressing unit ADU1 that can be addressed (selected) by an external addressing circuitry ADC, which is a second module of the controller CON. With the driving circuitry described up to now, two states of the field electrodes 11 can be realized, namely having the supply voltage V_{A} or a floating state.

As indicated by dashed lines, the driving circuitry preferably further comprises a second controllable switch CSW2 which allows to connect the field electrode 11 to a second voltage supply V_{B}. The second switch CSW2 can be controlled by the controlling circuitry COC under the control of a second addressing unit ADU2 that can be selected by the addressing circuitry ADC. As will be seen below, the first and the second addressing units ADU1, ADU2 can optionally be identical. The switches CSW1, CSW2 and the addressing units ADU1, ADU2 are typically placed under the electrode 11.

Several particular embodiments of the general layout of FIG. 7 will now be discussed in more detail with reference to the FIGS. 8 to 12.

FIG. 8 shows a first embodiment of a circuitry for driving a field electrode 11 in e.g. a dielectrophoretic array. The field electrode 11 is connected via a first Thin Film Transistor (TFT) T₁ to a first voltage supply V_{A} and via a second TFT T₂ to a second voltage supply V_{B}. The potentials V_{A} and V_{B} are e.g. AC sine waves of a given frequency and are phase-inverted, i.e. they have a phase difference of π between them. The electrode 11 is further shown to be connected to a load L, wherein said load is the impedance of the fluid and particles between the electrode 11 and its nearest neighbors, and where the second connection of the load L represents the nearest neighbor electrodes.

A V_{DATA} line passes digital data via an addressing transistor T₃, which is controlled by an addressing voltage V_{ADDR}, to a capacitor C for storage. A high value will select the N-type TFT T₂ and cause AC voltage V_{B} to be passed to the electrode 11 and load L, while a low value will cause the P-type TFT T₁ to be turned on and to pass AC voltage V_{A} to the electrode 11 and load L. Therefore an array of electrodes 11 can be individually programmed to pass an AC voltage of 0 (+) phase or π(−) phase to the electrode 11 and load L, i.e. DEP traps can be programmed to occur at any desired location within the array of electrodes.

The array of electrodes 11 can be addressed line by line by using the row address voltage V_{ADDR}. The addressing phase will be rapid (e.g. all rows are addressed in under 1 ms). Over this period of time the particles will hardly notice the disturbance of the addressing phase. There will then be a drive phase of a longer period.

A slightly more complex case is envisaged in FIG. 9, which shows a random access addressing. The voltages V_{ADDR ROW} and V_{ADDR COL} select in this case the individual electrode 11 to be addressed with new data.

In order to provide a still more simple circuit for enabling DEP trapping of the smallest particles, the circuit shown in FIG. 10 removes the reference voltage V_{REF} to which the capacitor C is coupled in the previous embodiments. The circuit operates with an address phase where the AC fields are stopped and for example V_{A} becomes 5V and V_{B} becomes −5V. Digital data is then applied to the node n, e.g. V=±5 V. After addressing all traps, the AC fields are started. If C₁=C₂, the voltage V is maintained and then the selected AC phase passes to the load:

The voltage V is maintained in the aforementioned case because the charge re-distribution on the capacitors C₁, C₂ cancels out with two anti-phase sine waves. If C₁=C₂ charge conservation at the node n causes initial voltage V to become the new voltage V′ according to:

Voltage V_{A} is DC and V_{A}′ is the AC voltage that follows, similarly for V_{B} and V_{B}′:

wherein voltage V_{M} is the midpoint voltage, e.g. 0V, and V_{R} is the amplitude. This yields:

If C₁=C₂, the DC voltage V is therefore maintained at the node.

The size of C₁ and C₂ can in principle be zero as one could use the TFT parasitic capacitance of the N and P drive TFTs T₁, T₂ for C₁ and C₂. However the parasitic capacitance of the addressing TFT T₃ causes asymmetry, so in reality one needs C₁ and C₂ to be quite a bit larger than this capacitance. Even so these capacitors can be hidden under the electrodes used to supply the AC phases and can therefore be considered as “for free” in terms of area consumption. This makes the circuit of FIG. 10 more compact than that of FIG. 9.

A further consideration that can be taken into account is that in an array the loads are all interlinked and that this can cause current flow between a line being addressed and lines that are not addressed. To provide good references, the power supply lines must not drop too much voltage. Therefore a simple addition to the circuit is an extra switch T₅ to turn off current flow at the addressing time as shown in FIG. 11.

In order to realize the embodiments with floating electrodes shown in FIGS. 4 to 6, electrodes with three states are required. A possible implementation of the associated driving circuitry is shown in FIG. 12. To generate the three states, two storage capacitors C₁ and C₂ are provided that allow the TFTs T₁ and T₂ which select the AC phase to be driven independently. Therefore V_{A} can be selected, or V_{B} can be selected, or neither to give the Z state (there is also the unwanted state of both V_{A} and V_{B} being selected, which has to be prevented by a proper control). The circuit shows that data are coming from a single data line, so the V_{ADDR1} and V_{ADDR2} pulses have to occur one after the other at the TFTs T₃ and T₆, respectively. It would also be possible to have two data lines and a single address line so that both capacitors could be addressed at the same time. Moreover, it is possible to further extend this to random access by additional addressing TFTs similar to that shown in FIG. 9.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A microelectronic device for manipulating a sample, comprising
a) a first voltage supply (VA);
b) a controller (CON) with a controlling circuitry (COC) and an addressing circuitry (ADC);
c) an array (10) of field electrodes (11), wherein each field electrode (11) is associated to
c1) a first controllable switch (T1, C, C1) for selectively connecting the field electrode (11) to the first voltage supply (VA); and
c2) a first addressing unit (T3, T4) that allows the controlling circuitry (COC) to control the first switch if the first addressing unit is selected by the addressing circuitry (ADC).

2. The microelectronic device according to claim 1,
characterized in that at least one of the field electrodes (11) can selectively be disconnected from any voltage supply (VA, VB).

3. The microelectronic device according to claim 2,
characterized in that a region of disconnected field electrodes (11) can be established that is surrounded by connected field electrodes (11).

4. The microelectronic device according to claim 1,
characterized in that it comprises a second voltage supply (VB), wherein each field electrode (11) is associated to a second controllable switch (T2, C, C2) for selectively connecting the field electrode (11) to the second voltage supply.

5. The microelectronic device according to claim 4,
characterized in that the second controllable switch (T2, C, C2) is coupled to a second addressing unit (T6), which allows the controlling circuitry (COC) to control the second switch if the second addressing unit is selected by the addressing circuitry (COC).

6. The microelectronic device according to claim 4,
characterized in that the second controllable switch (T2, C, C2) is coupled to the first addressing unit (T3, T4) which allows the controlling circuitry (COC) to control the second switch if the first addressing unit is selected by the addressing circuitry (ADC).

7. The microelectronic device according to claim 1,
characterized in that the first and/or the second controllable switch comprises a first or second capacitor (C, C1, C2), respectively, for storing switching-state information provided by the controlling circuitry (COC).

8. The microelectronic device according to claim 7,
characterized in that the first and/or the second controllable switch comprises a first or second transistor (T1, T2), respectively, that is connected with its gate to the first or second capacitor (C, C1, C2), respectively.

9. The microelectronic device according to claim 8,
characterized in that the gate of the second transistor (T2) is inverted with respect to the gate of the first transistor (T1).

10. The microelectronic device according to claim 7,
characterized in that the first and the second capacitors are realized by the same component (C).

11. The microelectronic device according to claim 7,
characterized in that the first and/or the second capacitor (C, C1, C2) is coupled to a reference voltage (VREF) with one terminal.

12. The microelectronic device according to claim 4,
characterized in that the first capacitor (C1) is coupled to the second voltage supply (VB) with one terminal, and that the first capacitor (C2) is coupled to the second voltage supply (VA) with one terminal.

13. The microelectronic device according to claim 12,
characterized in that the first and the second capacitors (C1, C2) are coupled to each other with their second terminal.

14. The microelectronic device according to claim 1,
characterized in that it comprises at least one additional switch (T5) that disconnects at least one field electrode (11) from any voltage supply (VA, VB) if the associated addressing unit (T3, T4) is selected.

15. The microelectronic device according to claim 1,
characterized in that the controller (CON) is adapted to drive the array (10) of field electrodes (11) such that particles (2) can be manipulated, trapped and/or moved in a sample chamber (1) above the array of field electrodes.

16. The microelectronic device according to claim 1,
characterized in that first and the second voltage supply provide phase-inverted alternating voltages (VA, VB).

17. The microelectronic device according to claim 1,
characterized in that it is realized in CMOS technology or Large Area Electronics, preferably with Low Temperature Poly-Silicon.

18. A method for the manipulation of particles (2) in a sample chamber (1) above an array (10) of field electrodes (11), wherein the field electrodes (11) are activated in a pattern comprising electrodes on a positive or a negative potential and electrodes on a floating potential (Z).

19. Use of the microelectronic device according to claim 1 for molecular diagnostics, biological sample analysis, or chemical sample analysis.
